(19) United States
(12) Patent Application Publication
(10) Pub. No.: US 2016/0201988 A1
(43) Pub. Date: Jul. 14, 2016

(54) CERAMIC CALCINER APPARATUS AND ASSOCIATED SYSTEMS AND METHODS

(71) Applicant: ADVANCED GREEN TECHNOLOGIES, LLC, Chandler, AZ (US)

(72) Inventor: Roy Edward McAlister, Phoenix, AX (US)

(21) Appl. No.: 14/911,012

(22) PCT Filed: Aug. 8, 2014
(86) PCT No.: PCT/US14/50431

§ 371 Date: Feb. 8, 2016

Related U.S. Application Data
(60) Provisional application No. 61/863,832, filed on Aug. 8, 2013.

(51) Int. Cl. F27B 14/14; F27B 14/06; F27B 14/08

(52) U.S. Cl. CPC F27B 14/14; F27B 14/08; F27B 14/06; F27B 2014/0812; F27B 2014/0887

(57) ABSTRACT

The present disclosure provides calciners configured to convert a feedstock into a calcined product.

### CROSS-REFERENCE TO RELATED APPLICATION(S)

This application claims priority to U.S. provisional patent application Ser. No. 61/863,832, filed on Aug. 8, 2013, the entire contents of which are incorporated herein by reference and relied upon.

### TECHNICAL FIELD

The present technology is directed to apparatus, systems and methods for calcining minerals.

### BACKGROUND

Calcination typically involves heating a feedstock (e.g., a mineral) in the presence of a processing fluid (e.g., air or oxygen) in an apparatus (referred to herein as a “calciner”) to cause thermal decomposition, phase transition, or devolatization. The reaction vessel may feature various shapes and designs depending on the mineral, required temperature, processing fluid, and many other factors. Some designs, for example open tube and pot calciners, disadvantageously permit particles and/or processing fluids to escape before the reaction occurs due to flow dynamics, resulting in lost material, inefficiencies and increased costs. Improved calciners and methods of calcination are needed.

### SUMMARY

In some embodiments, the present technology provides a calciner comprising a crucible, a heating element in proximity to the crucible and configured to heat the contents of the crucible, and optionally a delivery tube configured to provide a processing fluid to the crucible and/or to be articulated in a pattern within the crucible.

In other embodiments, the present technology provides a calciner comprising a crucible, a heating element in proximity to the crucible and configured to heat the contents of the crucible, a dome configured to seal a first portion of the crucible to enable a positive pressure to be applied to the first portion of the crucible, a conduit positioned through the dome configured to enable the positive pressure to be applied through the conduit to the first portion of the crucible, an insulated tube positioned through the dome and having a first end positioned in the first portion of the crucible, and a dispensing port configured to selectively enable material to be dispensed from the first portion of the crucible.

In other embodiments, the present technology provides a crucible assembly comprising an outer shell, an inner crucible housed inside the outer shell, a loading assembly disposed at least partially within the inner crucible and configured to enable material to be loaded or unloaded from the inner crucible, and may include a load-spreading insulating layer disposed between the outer shell and the inner crucible, the load-spreading insulating layer and may comprise a first heating element, and/or a second heating element, and/or at least one high strength filament.

In some embodiments, the present technology provides a method of preparing a calcined powder, the method comprising loading a precursor material into a calciner, heating the precursor material in the presence of a processing fluid, agitating the precursor material during at least a portion of the step of heating to form a calcined powder and/or and agglomerated form of such powder, and/or extracting the calcined powder and/or portions of the agglomerated form of the powder from the calciner.

These and other embodiments are described in more detail below.

### BRIEF DESCRIPTION OF THE DRAWINGS

FIG. 1 shows a calciner configured according to one embodiment of the present technology.

FIG. 2 shows a calciner configured according to one embodiment of the present technology including a removable cover.

FIG. 3 shows a calciner configured according to one embodiment of the present technology including an electrolyzer.

FIG. 4 shows a cross-sectional perspective view of a calciner configured according to another embodiment of the present technology including a dispensing port.

FIG. 5A is a cross-sectional perspective view of a calciner configured according to another embodiment of the present technology.

FIG. 5B shows an exploded view of the calciner of FIG. 5A.

FIG. 6 shows one embodiment of a process of calcining a feedstock according to the present technology.

### DETAILED DESCRIPTION

Various examples of apparatus, systems and methods for calcining and processing feedstock substances will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known steps, structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

### 1. Selected of Calciner Embodiments

In some embodiments, the present technology provides a calciner. The calciner comprises a component such as a tube or a crucible generally configured to enable a feedstock to be inserted therein, and is in proximity (e.g., is adjacent to or includes) one or more heating elements configured to transfer heat to the feedstock.

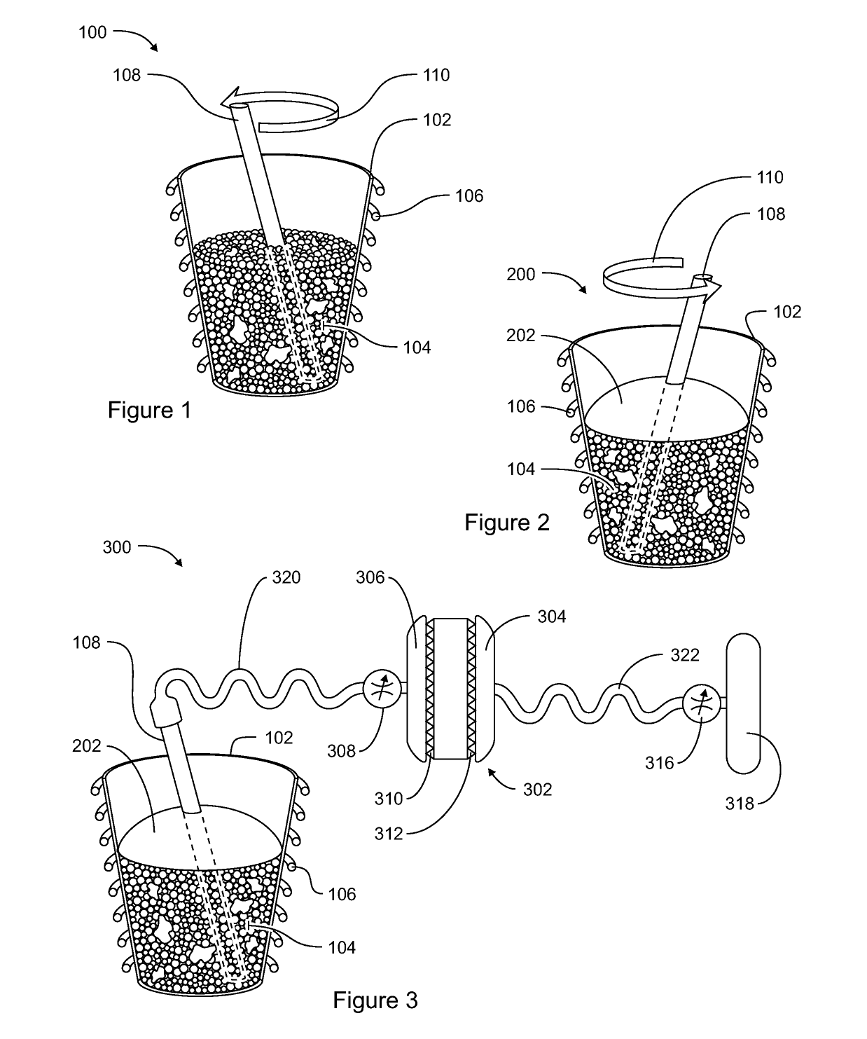

Referring now to FIG. 1, a calciner 100 configured according to one embodiment of the present technology comprises a crucible 102 into which a feedstock 104 may be introduced, one or more resistive, radiative or inductive heating elements 106 in proximity to the crucible 102 and configured to transfer heat the crucible 102 and/or to the feedstock 104, and a delivery tube 108 configured to provide a processing fluid to the crucible 102 and to be articulated in a pattern 110 within the crucible.

The feedstock 104 may comprise, consist of, or consist essentially of any suitable feedstock for calcining (e.g., to produce a calcined product such as a catalyst, a glass, a glass ceramic, and/or a ceramic). For example, the feedstock 104 may comprise one or more of: a metal, a mineral, and/or a recycled product that requires removal of water, carbon dioxide, volatile materials, and/or other unwanted substances. In some embodiments the feedstock 104 includes mineral concentrate, scrap iron, aluminum, magnesium, nickel, molybdenum, etc., various carbonates such as calcium, magnesium and/or potassium carbonates, along with other oxides such as silica, alumina, and/or calcium oxide. In some embodiments, the feedstock 104 is selected from the group consisting of: a hydroxide such as aluminum hydroxide, magnesium hydroxide, and/or calcium hydroxide, and/or a compound containing a rare earth substance.

The crucible 102 may be constructed of any suitable material that permits energy transmission such as radiation or heat transfer to the intended feedstock 104, yet is resistant to the temperatures and reactivity of the intended feedstock 104. For example, the crucible 102 may be formed of a refractory ceramic material such as alumina, magnesia, spinel, quartz, or fused silica; or a refractory metal selection including alloys from the platinum family. In some embodiments, the crucible 102 is formed of a composited ceramic material. The size and shape of the crucible 102 are not particularly limited; in some embodiments the crucible 102 has a cup or pot shape, such as a cylinder or tapered cylinder.

The one or more heating elements 106 can be located in close proximity to the crucible 102 in order to maximize efficiency of heat transfer to the feedstock 104 (e.g., through the wall(s) of the crucible 102). In some embodiments, the heating elements 106 are inductive heating elements and/or resistive elements which are operably connected to a controllable energy source.

The delivery tube 108 is oriented such that a distal end is within the crucible 102 while the proximal end is external to the crucible 102. The delivery tube 108 is configured to enable a processing fluid to be introduced to the crucible 102, and may be formed of any suitable material that is resistant to the temperature of the calcination process and to the reactivity of the feedstock and processing fluids. The processing fluid may include air, nitrogen, hydrogen, argon, oxygen, a halogen, and/or a nitrogen donor such as ammonia. In some embodiments, the delivery tube 108 may additionally configured to be articulated in a pattern 110, for example to sweep any suitable pattern 110 within the feedstock 104.

Referring now to FIG. 2, a calciner 200 configured according to another embodiment of the present technology includes a crucible 102 configured to hold a feedstock 104, a delivery tube 108, and one or more heating elements 106 configured similar to that described with respect to FIG. 1. Calciner 200 further includes a removable cover 202 configured to mate with the crucible 102 to retain one or more particles of the feedstock 104 and/or the processing fluid introduced through the delivery tube 108 that might otherwise be lost by flow dynamics. In such embodiments, the removable cover 202 may be of any suitable geometry configuration and geometry, and includes a channel through which the delivery tube 108 passes. The removable cover 202 may be formed from any material capable of resisting the temperature of the calcination process and the reactivity of the feedstock. For example, in some embodiments the removable cover 202 includes a woven ceramic filament or wire form, or may be a solid walled lid.

As shown in FIG. 3, a calciner 300 configured according to the present technology may include a crucible 102 configured to hold a feedstock 104, at least one heating element 106 and a delivery tube 108, and a removable cover 202 each configured substantially similar to that described with respect to FIGS. 1-2. The calciner 300 further includes an electrolyzer 302 configured to generate a processing reactant. In some embodiments, the electrolyzer 302 includes a first electrode 310 and a second electrode 312 in proximity to a first manifold 306 and a second manifold 304, respectively. The first manifold 306 is configured to collect the processing reactant generated by the first electrode 310 and provide it to the delivery tube 108, for example through a flexible conduit 320. The flexible conduit 320 may include a pressure regulator 308 to enable delivery of the processing reactant through the delivery tube 108 at a predetermined rate. The second manifold 304 may be configured to collect a byproduct from formation of the processing reactant, for example in a storage tank 318 which may be connected to the second manifold 304 via a second flexible conduit 322 optionally equipped with a second pressure regulator 316.

The processing reactant may be any suitable processing reactant including, but not limited to a halogen (e.g., bromine, iodine, chlorine and/or fluorine), oxygen, nitrogen, hydrogen, a transition metal carbonyl, a silane, and/or other fluids that provide metal or semiconductor donor capabilities. In embodiments wherein the processing reactant is a halogen, the electrolyzer 302 may be configured to convert a corresponding aqueous halogen salt or a corresponding fused halogen salt into its atomic components (e.g., a halogen processing reactant and a byproduct) via electrolytic decomposition. In some embodiments, other process reactants such as oxygen and/or hydrogen may be collected through manifold 304 and delivered through the second flexible conduit 322 and the second pressure regulator 316 to storage tank 318.

Calciners 100, 200 and 300 can be operated in batch or semi-continuous operations. In batch operations, feedstock 104 is added to the crucible 102 and after the desired conversion in some applications the calcined product may be melted and cast, extruded, or drawn from the crucible 102 for further processing. In semi-continuous operations, new feedstock 104 can be continuously or intermittently added to the crucible 102. In addition or in the alternative, calcined product produced by the calcination process can be removed from the crucible 102 as powder, prill or any other suitable agglomerated form.

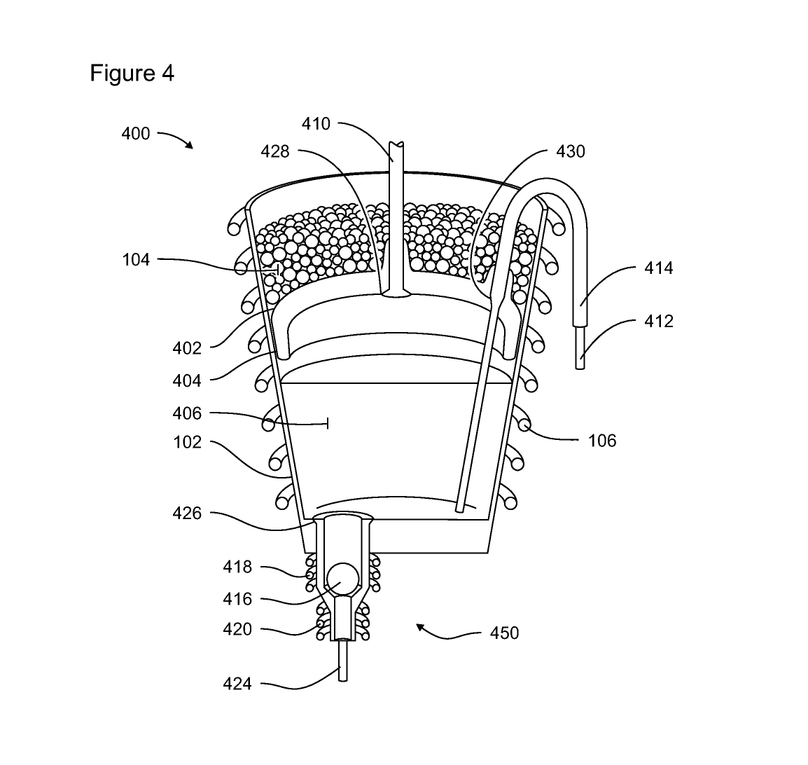

In some embodiments, the calciner is configured to be operated continuously. One such embodiment is shown in FIG. 4. The calciner 400 in such embodiments may include feedstock 104 is added at one location of the crucible 102 while calcined product is extracted from the crucible 102 at second, different location. In certain applications, feedstock 104 is added above a melt and heat that is transferred to the raw charge from the melt provides considerable improvement in process efficiency compared to conventional approaches of calcining, grinding, reheating and melting.

Calciner 400 includes a crucible 102 configured to hold a feedstock 104, at least one heating element 106 and a delivery tube 108 each configured substantially similar to that described with respect to FIGS. 1-3. The calciner 400 further includes a cover 402 having a tapered seal lip 404 which mates with the inner wall of the crucible 102 to enable the crucible 102 to be operated under positive pneumatic pressure. In some embodiments, pneumatic pressure is applied through conduit 410. The conduit 410 may include a bell lip 428 which mates with the cover 402 under positive pressure to seal a portion of the crucible 102. In some embodiments, positive pressure is applied through the conduit 410 in order to dispense a melt 406 (e.g., feedstock 104 that has been heated by the heating element(s) 106) within crucible 102 and, in some embodiments, through an insulated tube 414 having a desired cross section (e.g., tubing, rod, strip, etc.) to provide a melted calcined material 412 having the desired cross section of the insulated tube 414. In some embodiments, the insulated tube 414 includes a tapered seal portion 430 configured to. In some embodiments, the cover 402 may include one or more auger(s) or other suitable conveyers to transport the feedstock 104 through the cover 402 into the melt 406. In other embodiments, the cover 402 may be occasionally lifted (e.g., the seal with the crucible walls may be temporarily broken) to add feedstock 104 to the melt zone 406.

In some embodiments, the calciner 400 includes a dispensing port 450 configured to enable melted material 406 to be removed from the crucible 102 under positive pressure and/or by force of gravity. The dispensing port 450 may include bell lips 426 to form a seal with the inner surface of the crucible 102, for example under positive pressure applied through the delivery tube 108. In some embodiments, the dispensing port 450 includes bottom check valve 416. The dispensing port may be heated (e.g., by heating elements 418 and/or 420). In some embodiments, the bottom check valve 416 is activated by operation of a solenoid 418. The extracted calcined product 424 may have a cross-sectional shape similar to that of the shape of the dispensing port 450, such as in the shape of a tube, a bar, a strip etc.

In some embodiments, a process gas may be introduced through conduit 410 and/or through the dispensing port 450. For example, in some embodiments, the process gas is produced by an electrolyzer similar to electrolyzer 302 shown in FIG. 3 and introduced through conduit 410 and/or through the dispensing port 450.

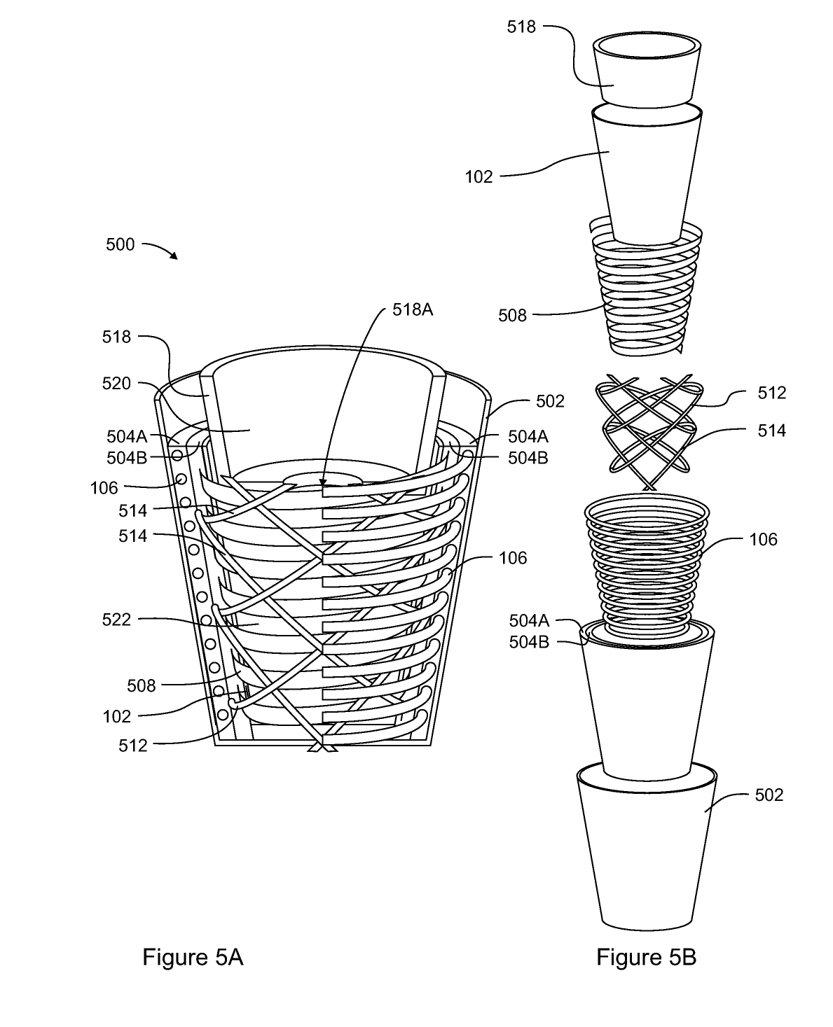

As shown in FIG. 5A, a calciner 500 configured according to another embodiment of the present technology includes a crucible 102 configured to hold a feedstock in a melt zone 522. A loading assembly 518 is positioned above the crucible 102; in some embodiments at least a portion of the loading assembly 518 is positioned inside an upper portion of the crucible 102. The loading assembly includes a channel 518A through which feedstock can pass from zone 520 into the melt zone 522 of the crucible 102. The crucible 102 is in close proximity to one or more resistive heating elements 508. For example, the resistive heating element 508 may be a generally spiral-shaped strip of conductive material that complements the outer profile of the crucible 102. In some embodiments, the resistive heating element 508 is encased in an insulation layer 504B. The insulation layer 504B may be in direct contact with the outer surface of the crucible 102. The calciner 500 may also include one or more inductive heating elements 106 configured to provide heat to the crucible 102 and its contents. In some embodiments, the inductive heating elements 106 are encased in a second insulation layer 504A, which may be disposed around the first insulation layer 504B. In some embodiments, the second insulating layer 504A is disposed adjacent to the crucible 102, while the first insulating layer 504B is disposed around the second insulating layer 504A. Insulating layers 504A and 504B may be made of various similar preparations of ceramic, glass ceramic, silicon carbide, carbon fibers, chips of exfoliated graphite and/or expanded graphene media.

High strength filaments 512 and/or axial reinforcing filaments 514 are disposed between the first and second insulating layers 504A, 504B in a suitable pattern (e.g., a lattice) to increase the strength and/or rigidity (e.g., hoop strength) of the calciner 500. The high strength filaments 512 and the axial reinforcing filaments 514 may comprise any suitable material including, for example, carbon filaments, silicon carbide, glass-ceramics, selected metals, and/or ceramic fibers.

An outer shell 502 surrounds the outermost insulating layer 504A or 504B and provides electrical, thermal, chemical and mechanical protection and support of the calciner components. The outer shell 502 may be formed of a refractory ceramic material such as alumina, magnesia, spinel, quartz, or fused silica; or a refractory metal including alloys from the platinum family.

In operation, assembly 518 provides loading of material to be pre-melt processed including calcining, removal of water including water of hydration, de-aeration, and mixing of precursor ingredients that are subsequently conveyed from zone 520 and added to melt zone 522. Heating elements 106 and/or 508 provide heat production in melt zone 522 to enable final melting and refinement including chemical process and temperature adjustments required to extrude, draw, gob and press mold parts made of the composition dispensed from zone 522.

Any calciner of the present technology may further include additional features and elements common to calciners known in the art. For example, any calciner provided herein may further include instrumentation (e.g., sensors) configured to monitor and control the temperature, pressure, and other conditions of operation of each zone and respective process. The calciners of the present disclosure may be operatively connected to a controller (e.g., a computer) configured to control one or more operating parameters (e.g., temperature, time of heating, flow rate of the processing fluid and/or the process reactant, etc.).

### 2. Selected Methods Of Calcining Feedstock

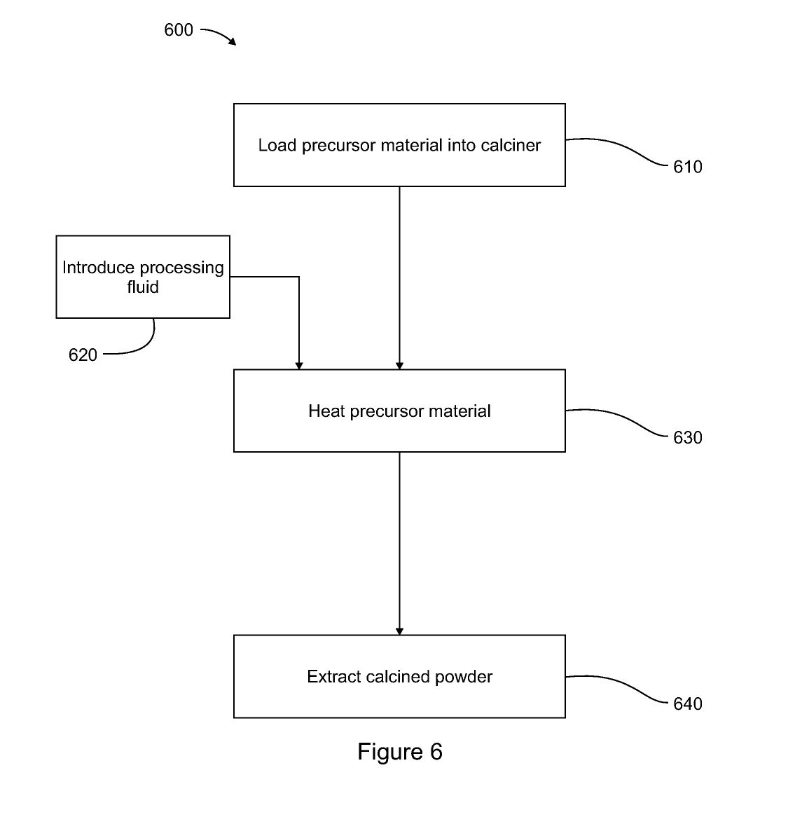

As shown in FIG. 6, the present technology provides a method 600 of calcining a feedstock, the method 600 comprising loading a precursor material into a calciner in a first step 610, heating the precursor material in the presence of a processing fluid in a subsequent step 630, and extracting the calcined powder from the calciner in another step 640.

The step 610 of loading the precursor material into the calciner may comprise providing a feedstock and loading the feedstock into the calciner 100, 200, 300, 400 or 500 (e.g., into the crucible 102). In some embodiments, the step 610 is performed as a batch process. In such embodiments, a bolus of feedstock is loaded into the calciner and the step 630 of heating the precursor material begins after the bolus of feedstock is loaded into the calciner. In other embodiments, the step 610 of loading the precursor material is performed continuously. In such embodiments, the feedstock is continuously or semicontinuously loaded into the calciner 100, 200, 300, 400 or 500 (e.g., into the crucible 102) while at least a portion of the step 630 of heating the precursor material is also performed.

In step 620, a processing fluid is introduced into the calciner 100, 200, 300, 400 or 500 (e.g., into the crucible 102). The processing fluid may be introduced through a delivery tube 108 or a conduit 410 as described more fully above. In some embodiments, the step 620 of introducing the processing fluid comprises generating the processing fluid, for example by electrolysis of a substrate.

In step 630, heat is applied to the precursor material through the walls of the crucible 102. The may be accomplished by energizing the heating elements (e.g., inductive and/or resistive heating elements 106, 508). The heat may be applied to the feedstock for a predetermined time, or may be applied until a phase transition or other endpoint parameter is detected by a sensor. In embodiments wherein the calcination method is continuous, the heat may be applied for a predetermined time by transporting the feedstock through the crucible at a predetermined rate corresponding to a desired residence time (e.g., a desired mean or median residence time). Step 630 may further comprise agitating the precursor material, for example by articulating a pattern 110 with a delivery tube 108 in order to sweep a similar pattern to pattern 110 within the feedstock 104.

In some embodiments, the step 620 of introducing the processing fluid and/or the step 630 of heating the precursor material comprises applying positive pressure to the crucible 102. In some embodiments, the positive pressurization is provided by introducing a surplus of the processing fluid in step 620. In addition or in the alternative, the positive pressurization may be provided by heating the crucible 102 in step 630 after sealing the crucible 102 with a removable cover 102, 202. After step 630, at least a portion of the feedstock (e.g., some of the feedstock, most of the feedstock, substantially all of the feedstock, or all of the feedstock) has been calcined.

The step 640 of extracting the calcined powder may comprise any suitable method of removing the calcined powder from the crucible. In some embodiments, the calcined powder is removed in a melt form, for example through a dispensing port 450 or through a through an insulated tube 414. In some embodiments, the extracted melted calcined powder is cooled and optionally ground to form the calcined powder

Heating by resistive and/or inductive elements such as 106 along with process gas treatments enables very rapid processing of inexpensive feedstocks, such as minerals and recycled materials, glass, ceramic, and metals such as aluminum, magnesium, steel, stainless steel and super alloys. Final temperature adjustments with inductive and/or resistive elements 420 and/or 418 provides precision performance of finishing operations such as various heat treating and/or nucleation processes along with extrusion, drawing, and/or gob-molding in compression forming tooling.

In some embodiments, the method 600 further includes heat treating the dispensed material 412 and/or 424, for example by surface quenching, to retain amorphous surface layers that are compressively loaded by balancing tensile loading of subsurface zones that are characterized various degrees and orientations of crystallized microstructures. In some embodiments, the method 600 includes reheating and/or controlled cooling for various purposes, case hardening, or other modifications by introduction of one or more nucleating and/or compounding agents such as boron, nitrogen, oxygen, fluorine, carbon, silicon, and/or other substances.

Embodiments of the methods disclosed herein provide calcination of feedstock substances to form powders and/or agglomerated forms. Such powders and agglomerated forms may be used for any application in which calcined powders produced by other means are typically used.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A calciner comprising:
a crucible;
a heating element in proximity to the crucible and configured to heat the crucible; and
a delivery tube configured:
to provide a processing fluid to the crucible, and
to be articulated in a pattern within the crucible.

2. The calciner of claim 1, wherein the heating element is disposed around the crucible in one or more loops.

3. The calciner of claim 1 or claim 2 further comprising a removable cover configured to retain one or more components in the calciner.

4. The calciner of claim 3, wherein the removable cover includes a void through with the delivery tube is positioned.

5. The calciner of claim 3 further comprising an electrolysis apparatus connected to the delivery tube by a flexible conduit, wherein the electrolysis apparatus is configured to electrolytically decompose an intermediate feedstock to form a process reactant.

6. A calciner comprising:
a crucible;
a heating element in proximity to the crucible and configured to heat the crucible;
a dome configured to seal a first portion of the crucible to enable a positive pressure to be applied to the first portion of the crucible;
a conduit positioned through the dome configured to enable the positive pressure to be applied through the conduit to the first portion of the crucible;
an insulated tube positioned through the dome and having a first end positioned in the first portion of the crucible; and
a dispensing port configured to selectively enable material to be dispensed from the first portion of the crucible.

7. The calciner of claim 6 further comprising a second heating element disposed about the bottom check valve.

8. The calciner of claim 6 or claim 7, wherein the dispensing port comprises a bottom check valve and a solenoid configured to displace the bottom check valve upon energizing.

9. The calciner of any one of claims 6 to 8, wherein the crucible further comprises a second portion configured to contain a precursor material.

10. The calciner of claim 9 further comprising a conveyor configured to transport the precursor material from the second portion of the crucible to the first portion of the crucible.

11. The calciner of claim 10, wherein the conveyor is an auger.

12. A crucible assembly comprising:
an outer shell;
an inner crucible housed inside the outer shell;
a loading assembly disposed at least partially within the inner crucible and configured to enable material to be loaded or unloaded from the inner crucible; and
a load-spreading insulating layer disposed between the outer shell and the inner crucible, the load-spreading insulating layer comprising:
a first heating element,
a second heating element, and
at least one high strength filament.

13. The crucible assembly of claim 12, wherein the load-spreading insulating layer comprises an inner layer housing the first heating element, and an outer layer comprising the second heating element.

14. The crucible assembly of claim 12, wherein the first heating element is a resistive heating element.

15. The crucible assembly of any one of claims 12 to 14, wherein the second heating element is an inductive heating element.

16. The crucible assembly of any one of claims 12 to 15, wherein the at least one high strength filament comprises axial reinforcement filaments.

17. The crucible assembly of any one of claims 12 to 16, wherein the loading assembly includes a port configured to enable material to be conveyed from the loading assembly to the inner crucible.

18. A method of preparing a calcined powder, the method comprising:
loading a precursor material into a calciner;
heating the precursor material in the presence of a processing fluid;
agitating the precursor material during at least a portion of the step of heating to form a calcined powder; and
extracting the calcined powder from the calciner.

19. The method of claim 18, wherein the method is continuous.

20. The method of claim 18 or claim 19, wherein the processing fluid is provided to the calciner through a delivery tube.

21. The method of any one of claims 18 to 20, wherein the processing fluid is generated by an electrolyzer operatively connected to the delivery tube.

22. The method of any one of claims 18 to 21, wherein the processing fluid comprises a halogen.

23. The method of any one of claims 18 to 20, wherein the calciner comprises a removable cover configured to retain the processing fluid in the calciner.

24. The method of claim 19, wherein the calciner comprises a dispensing port, and wherein the step of extracting comprises extracting a calcined melt through the dispensing port.

25. The method of claim 24 further comprising cooling the calcined melt to form the calcined powder.

26. The method of any one of claims 18 to 25, wherein the calciner comprises:
a crucible;
a heating element in proximity to the crucible and configured to heat the crucible; and
a delivery tube configured:
to provide a processing fluid to the crucible, and
to be articulated in a pattern within the crucible.

27. The method of any one of claims 18 to 25, wherein the calciner comprises:
a crucible;
a heating element in proximity to the crucible and configured to heat the crucible;
a dome configured to seal a first portion of the crucible to enable a positive pressure to be applied to the first portion of the crucible;
a conduit positioned through the dome configured to enable the positive pressure to be applied through the conduit to the first portion of the crucible;
an insulated tube positioned through the dome and having a first end positioned in the first portion of the crucible;
a dispensing port configured to selectively enable material to be dispensed from the first portion of the crucible.

28. The method of any one of claims 18 to 25, wherein the calciner comprises a crucible assembly, the crucible assembly comprising:
an outer shell;
an inner crucible housed inside the outer shell;
a loading assembly disposed at least partially within the inner crucible and configured to enable material to be loaded or unloaded from the inner crucible; and
a load-spreading insulating layer disposed between the outer shell and the inner crucible, the load-spreading insulating layer comprising:
a first heating element,
a second heating element, and
at least one high strength filament.
